(19) United States
(12) Patent Application Publication
(10) Pub. No.: US 2025/0232018 A1
(43) Pub. Date: Jul. 17, 2025

(54) SYSTEM AND METHOD FOR DETERMINING AN IDENTITY OF A USER

(71) Applicant: TACYT LIMITED, London (GB)

(72) Inventors: Ian TOMLINSON, London (GB); Henry Matthew Lawrence FLETCHER, London (GB); James Edward BUCKLEY, London (GB); David Kassim MOHAMAD, London (GB); Christian Valentine BURTON, London (GB)

(21) Appl. No.: 18/850,947

(22) PCT Filed: Mar. 28, 2023
(86) PCT No.: PCT/EP2023/058049

§ 371 Date: Sep. 25, 2024

(30) Foreign Application Priority Data
Mar. 29, 2022 (GB) 2204455.6

(51) Int. Cl. G06F 21/32; G06F 3/01; G06F 3/02

(52) U.S. Cl. CPC G06F 21/32; G06F 3/016; G06F 3/0202

(57) ABSTRACT

A system. The system includes at least one mechanical interaction element configured for interaction with the user, a sensor configured to measure the interaction by a user with the at least one mechanical interaction element so as to obtain interaction data, a data storage unit for storing previously acquired interaction data relating to the user, and a processor configured to compare the obtained interaction data to the stored interaction data.

### FIELD OF THE INVENTION

The present invention relates to a system and method.

### BACKGROUND

People increasingly rely on computing devices in all spheres of life and therefore ensuring secure access thereto is of paramount importance. A cornerstone of avoiding security breaches is by determining a user's identity and so determining whether he/she should be granted access to information on or capabilities of a particular computing device.

For example, a computing device may be used to grant access to a computer network or a physical building. In this case, it is desirable that the identity of any user wishing to access the network or building, is determined prior to granting the access to prevent breaches of security.

Various methods of determining a user identity are known, including, for example, inputting a password or tracing a pattern to replicate a pre-set unlock gesture. Such methods, however, can be slow and cumbersome to use. Furthermore, they are also susceptible to simple shoulder surface attacks. Short passwords and unlock gestures can be easily retrieved by simply observing a user authenticating on his/her device once, while longer and more elaborate ones significantly slow down the user determination process.

Biometric identification, that is identification based on body measurements and/or calculations related to human characteristics, provides an alternative that is both easier to use (ensuring compliance) and more secure. For example, fingerprint recognition and face recognition have been widely used in the field of mobile electronic devices. However, such means for user identity determination can be unreliable under sub-optimal conditions of use or under conditions which are different to the initial training conditions. For example, most fingerprint recognition systems struggle to operate if a user's finger is misplaced or wet and cannot operate at all if the user is wearing gloves. Similarly, face recognition systems often struggle to operate under low-lighting conditions or when the user has not positioned their face suitably with respect to a camera of the face recognition system.

It is therefore desirable to provide an alternative user determination system which is easy and intuitive to use and is also capable of reliably determining a user's identity under a wide range of conditions of use.

The present invention has been designed in view of the above considerations.

### SUMMARY

Accordingly, in embodiments of a first aspect of the invention a system for includes:
at least one mechanical interaction element configured for interaction with the user;
a sensor configured to measure the interaction by a user with the at least one mechanical interaction element so as to obtain interaction data;
a data storage unit for storing previously acquired interaction data relating to the user; and
a processor configured to compare the obtained interaction data to the stored interaction data.

The system according to this aspect includes at least one mechanical interaction element which can be easily and intuitively engaged with by the user under a variety of conditions of use. A sensor of the system is then able to measure the interaction, providing obtained interaction data which can be used, for example, for a determination of the user's identity. That is, the system may be a user identification system for determining a user identity using interaction data obtained from the user, and wherein the processor is configured to compare the obtained interaction data to the stored interaction data so as to determine a degree of similarity between the obtained and stored interaction data, to allow the user identity to be determined. The obtained interaction data may be provided, for example, to a trained machine classifier to compare it to pre-stored historical interaction data. The comparison process may include, for example, the use of fuzzy analytics to establish a degree of similarity between the two data sets. Thus, a reliable determination of the user identity can be achieved by a system which is easy and intuitive to use. The system may be a health monitoring system for determining a user's health using interaction data obtained from the user, and wherein the processor is configured to compare the obtained interaction data to the stored interaction data so as to determine whether the user's health has changed

The invention includes the combination of the aspects and preferred features described except where such a combination is clearly impermissible or expressly avoided.

Optional features of the invention will now be set out. These are applicable singly or in any combination with any aspect of the invention.

The interaction data obtained by the sensor may be one or any combination of: force data, displacement data, time data. These types of data can be indicative of a user's identity, cannot be easily replicated by a different user, and are usually not affected by variations in the external conditions during use, e.g. variations in the ambient light or humidity or presence of protective apparel, such as gloves. This makes them suitable for achieving reliable user identification.

The interaction data may include force data and/or displacement data which is within a range of 1 mm to 100 mm. That is, the force data and/or displacement data may be indicative of a range of motion of the mechanical interaction element which is within the range 1 mm to 100 mm.

The interaction data obtained by the sensor may comprise a plurality of sets of interaction data, collected over a plurality of time periods, each set of interaction data being spaced at least 1 ms, 5 ms, 10 ms, 50 ms, or 100 ms apart.

The sensor may be integrated with another object or entity. For example, the sensor may be integrated into a door handle or other part of a door such that when the user grasps or pushes the door handle or other part of the door interaction data is obtained. This obtained interaction can then be used to determine whether or not to unlock the door, for example by comparison with previously acquired interaction data. Similarly, the sensor may be integrated with a part of a car, e.g. the steering wheel, door handle, gearstick, or handbrake. When the user interacts with it, a determination can be made by comparing the interaction data and previously acquired interaction data as to whether the user is considered to be identified. If they are, the steering wheel/car door may unlock or the engine may be allowed to start.

The processor may be configured to store the obtained interaction data for comparison with future obtained interaction data. Each set of interaction data corresponding to a given entry may have been recorded over a limited time period, for example no more than 60 seconds, 30 seconds, or 10 seconds. Each data set (which can comprise one or more sets of interaction data) can be compared with a subsequent or prior data set to identify overall similarities and differences, but also specific similarities and differences using data comparison algorithms.

The at least one mechanical interaction element may be configured for interaction with the user in that it may comprise a surface or surfaces which the user may push or pull so as to provide interaction. The mechanical interaction element may be configured for interaction with the user so as to move a minimum distance during interaction, for example 1 mm, 2 mm, 5 mm, 1 cm, or 5 cm. For example, the at least one mechanical interaction element may be a pin. Interacting with a pin is easy and intuitive and it is possible to extract interaction data suitable for user identity determination. Furthermore, a user can interact with the pin by applying a force onto it. Therefore, the user can also interact with the pin even when wearing gloves without compromising the reliability of the performed user identification. This is particularly useful in industrial applications where users may necessarily wear protective apparel while performing most tasks. Advantageously, such types of interactions with a pin are also not easily affected by external conditions such as levels of ambient light or humidity. This also improves the reliability of the user identification system.

There may be a plurality of interaction elements, each being a pin, the plurality of pins being arranged to form a grid. Similarly to a single pin, a grid of pins is easy and intuitive to interact with and a user can perform the interaction even, for example, when wearing gloves and/or under sub-optimal external conditions. Furthermore, by using a grid of pins, more detailed interaction data can be obtained which further increases the reliability of the user identity determination performed by the system.

The processor may be configured to derive a characteristic, indicative of the identity of the user, from the obtained interaction data and to use the derived characteristic in the comparison. That is, the obtained interaction data may be processed to arrive at a derived characteristic, and it is this derived characteristic which is used in the comparison in some embodiments where the characteristic is derived. The comparison to determine the degree of similarity between the obtained and stored interaction data may use one or both of the originally obtained interaction data (i.e. unprocessed) and the derived characteristic, that is the system may consider both, or only one, in determining the degree of similarity. Deriving an additional characteristic from the obtained raw data can be beneficial because a more detailed and therefore reliable user identity determination can be achieved.

The characteristic may include shape information, wherein the shape information may be used to determine the shape of a body part of the user used to interact with the interaction element. For example, a user may interact with the interaction element using their hand. The system would thus obtain interaction data and derive shape information from the interaction data characterising the shape of the user's hand to further use in the user identity determination. Shape information is largely unaffected by the external conditions during use such as level of light or humidity, or the presence of protective apparel, such as gloves.

The data storage unit and processor may be located in a server, or another computing device, which is connected to a data collection unit, the data collection unit containing the at least one mechanical interaction element and the sensor. Thus, the data collection unit may be designed to be compact and portable and the user could conveniently connect it to the data storage unit and processor whenever they need to determine their identity. Alternatively, the data storage unit and processor may be located in the same data collection unit which also contains the at least one mechanical interaction element and the sensor.

The user identification system may further comprise a drive mechanism, coupled to the mechanical interaction element, and configured to provide a force to the mechanical interaction element in response to the user interaction. This response force can be used to provide feedback to the user.

In a second aspect, embodiments of the present invention provide a method using the system of the first aspect is provided, the method including the steps of:
measuring an interaction by a user with the at least one mechanical interaction element and obtaining interaction data; and
comparing the obtained interaction data to stored interaction data.

The method may be for determining a user identity using interaction data obtained from the user, and further comprises a step of determining a degree of similarity between the obtained and stored interaction data, to allow the identity of the user to be determined.

The method may be for determining a user's health using interaction data obtained from the user, and further comprises a step of determining whether the user's health has changed.

The system as used in the second aspect may have any one or any combination insofar as they are compatible of the optional features of the system of the first aspect.

The method may further include a step of deriving a characteristic, indicative of the identity of the user, and using the derived characteristic in the comparison. As discussed above with reference to the system of the first aspect, the characteristic may include shape information, relating to a shape of the body part the of the user used to interact with the interaction element. Thus, in addition to using the obtained raw interaction data for user determination purposes, it can be beneficial to derive an additional characteristic from the interaction data to achieve a more elaborate and therefore reliable user identity determination. Shape information, relating to a shape of the body part the of the user used to interact with the interaction element, for example, the shape of the user's hand, is particularly useful for user identity determination as it is indicative of the user's identity and it is generally not affected by external conditions during use, as discussed previously.

The method may further comprise providing a force to the mechanical interaction element, via a drive mechanism coupled to the mechanical interaction element, in response to the user interaction.

The method may be a computer-implemented method.

In a third aspect, embodiments of the present invention provide a method of registering users with system, for example a user identification system, the method including the steps of:
measuring, via a sensor, an interaction by a user with at least one mechanical interaction element and obtaining interaction data; and
storing the obtained interaction data for use in a method for determining a user identity.

This method of registering users allows to create a database of interaction data associated with different users which can be then compared to newly obtained interaction data during user identity determination. The stored information can also be used for training a machine learning software to promote high accuracy of the user identity determination process that can be performed using the stored data.

The method may be a computer-implemented method.

The method of the third aspect may be performed on or using the system of the first aspect, including any of the optional features set out with reference thereto. That is, the method may be performed on or using the sensor, at least one mechanical interaction element, data storage unit, and processor of the system of the first aspect.

The interaction data may be one or any combination of: force data, displacement data, time data. These types of data can be indicative of a user's identity, cannot be easily replicated by a different user, and are usually not affected by variations in the external conditions during use, e.g. variations in the ambient light or humidity, or the presence of protective apparel. Therefore, they are suitable for achieving a reliably user identity determination.

The method may further comprise deriving, from the obtained interaction data, a characteristic indicative of the user, and storing the characteristic for use in the method of determining the user identity. As discussed with reference to the method of the second aspect, the characteristic may include shape information, relating to a shape of the body part the of the user used to interact with the interaction element. Thus, by deriving an additional characteristic from the interaction data to use in the comparison, it is possible to achieve a more elaborate and therefore reliable user identity determination.

In a fourth aspect, embodiments of the present invention provide a user registration system, the user registration system including:
at least one mechanical interaction element configured for interaction with the user;
a sensor configured to measure the interaction by a user with the at least one mechanical interaction element so as to obtain interaction data; and
a data storage unit configured to store the obtained interaction data.

The user registration system may be used for registering users with a user identification system according to the first aspect.

This system is suitable for implementing the method of the third aspect and can optionally include additional features suitable for implementing the optional method steps of the third aspect. The system of the fourth aspect may include or be formed of components of the system of the first aspect.

Further aspects of the present invention provide: a computer program comprising code which, when run on a computer, causes the computer to perform the method of the second and/or third aspect; a computer readable medium storing a computer program comprising code which, when run on a computer, causes the computer to perform the method of the second and/or third aspect; and a computer system programmed to perform the method of the second and/or third aspect.

### BRIEF DESCRIPTION OF THE DRAWINGS

Embodiments of the invention will now be described by way of example with reference to the accompanying drawings in which:

FIG. 1 shows a schematic of a data collection unit;

FIG. 2 shows a schematic of user identification system;

FIG. 3 shows a schematic of a user registration system according to an aspect of the present invention;

FIGS. 4A and 4B show an external perspective view and an internal perspective view respectively of a data collection unit;

FIGS. 5A to 5D show a perspective view, two different sectioned perspective views, and a sectioned side elevation respectively of the data collection unit of FIG. 1 with a pin guard omitted;

FIGS. 6A and 6B show perspective views of the drive mechanism and pin of the data collection unit of FIG. 1 and FIG. 6C shows a detailed view of region A of FIG. 6B;

FIGS. 7 and 8 show flow charts of the steps of respective variants of a method of determining a user identity according to aspects of the present invention;

FIGS. 9 and 10 show flow charts of the steps of respective variants of a method of registering users according to aspects of the present invention; and

FIG. 11 shows a flow chart of the steps of a method of monitoring a user's health according to aspects of the present invention.

### DETAILED DESCRIPTION AND FURTHER OPTIONAL FEATURES

Aspects and embodiments of the present invention will now be discussed with reference to the accompanying figures. Further aspects and embodiments will be apparent to those skilled in the art.

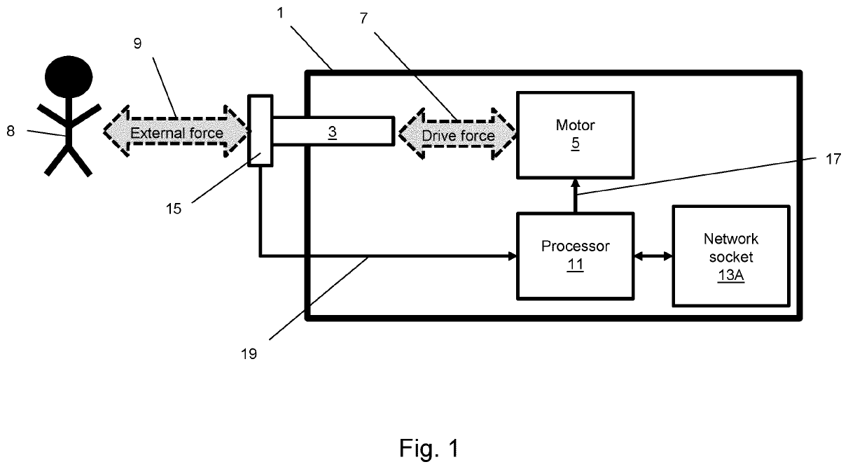

FIG. 1 shows a schematic of a data collection unit. The unit 1 comprises a mechanical interaction element 3 such as a pin or rod which may be connected to a drive mechanism operable to provide reaction or response forces to the user when they interact with the mechanical interaction element. The drive mechanism may include a motor for providing a driving force to the interaction element or a spring which is placed in tension/compression when interacted with by the user, the spring being attached to the interaction element. Other interaction elements may be used such as surfaces, panels, members, or other suitable geometries. In further embodiments, the interaction element comprises one or more flexible membranes encasing a fluid. In these embodiments, the drive mechanism may be a pump which can increase or decrease the fluid pressure inside the flexible membrane by draining or adding fluid. A drive mechanism in the form of a motor 5 provides a drive force 7 to the interaction element which can causes it to move in response to a user interaction. The interaction element may also be moved manually by a user 8 applying an external force 9 to the interaction element. Thus, the motion of the interaction element depends on the direction and magnitude of the sum of the drive force and the external force.

A processor 11 is provided to control the drive mechanism 5 and the drive force 7 as required. A position encoder (not shown, but which may be located within the motors themselves) reports a current location of the interaction element 3 to the processor 11. Additionally, a sensor 15 is provided, which in some embodiments is physically separate to the drive mechanism, and which measures a level of interaction by the user 8. Typically, the sensor is a force sensor, such as a load cell, which directly measures the external force 15 applied by the user to the interaction element. For example, the force sensor may be a Richmond 210™ in-line load cell which is capable of measuring forces of 0 to 100N. The measured external force is reported to the processor. In embodiments where the interaction elements comprises one or more flexible membranes encasing a fluid, the sensor 15 may be a pressure sensor configured to sense the pressure of the fluid, or the sensor may measure an amount of fluid entering or exiting the space defined by the flexible membrane via an exit conduit.

The measured position and the measured external force form interaction data which the processor 11 provides to a network socket 13A. The interaction data may optionally also include time information characterising the interaction.

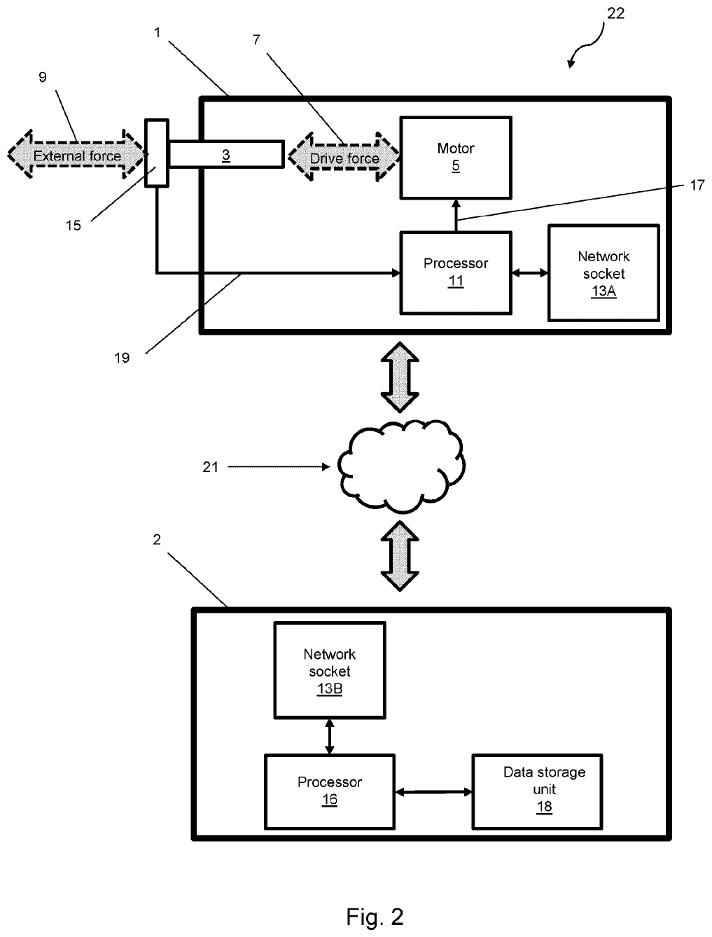

FIG. 2 shows a schematic of a user identification system comprising a data collection unit 1 connected to a server 2 by a network 21. Typically, the network is the internet. However, the network could also be a private wired or wireless connection. The server 2 comprises a data storage unit 18 for storing interaction data, a processor 16 for comparing the interaction obtained by the data collection unit 1 to the interaction data stored by the data storage unit, and a network socket 13B. The interaction data is provided, via the network socket 13B, to the server 2. Then, the processor 16 of the server 2 accesses the obtained interaction data containing a measured position of the interaction element 3 and a measured external force 9 applied to the interaction element. Thus, the processor 16 of the server 2 can determine a degree of similarity between the obtained and stored interaction data, for example by employing fuzzy analytics, to allow a user's identity to be determined.

Additionally, the processor 16 of the server 2 may be configured to derive a characteristic, which is indicative of the identity of the user 8, from the obtained interaction data, and to compare it to a corresponding stored characteristic to determine a degree of similarity between the two for user identification purposes.

Both the processor 11 of the data collection device 1 and the processor 16 of the server 2 may be configured to derive characteristics from interaction data. For example, the processor 16 of the server 2 may derive a characteristic from the obtained interaction data and another characteristic from the interaction data stored in the data storage unit 18, and subsequently compare the two characteristics. The processors 11, 16 may derive the characteristics by performing one or more calculations using obtained interaction data and a pre-set calculation model, e.g. a formula or set of formulae.

The characteristic may be shape information. For example, the user 8 may interact with the mechanical interaction element 3 using their hand. The processor 16 of the server would then access the obtained interaction data and derive shape information from it characterising the shape of the user's hand to further use in the user identity determination. Shape information is suitable for user identity determination as it is largely unaffected by the external conditions during use such as level of light or humidity, or the presence of protective apparel, such as gloves.

In some scenarios a user 8 may apply an external force to the mechanical interaction element 3 which is in opposition to and in excess of the drive force. This could cause interaction measurement gaps or backlash in the system 22 which hinders the performance of the system and the overall user experience, and it is therefore desirable to prevent those. To do this, the interaction element may be allowed to drive the drive mechanism in reverse.

In this way, the position of the interaction element may be continuously monitored as it is pushed in the reverse direction, preventing measurement gaps or backlash in the system 22. Alternatively, the interaction element may be allowed to slip in the drive mechanism and its position may be remeasured to prevent backlash.

In another embodiment of the user identification system, the processor 11 in the data collection unit is further configured to perform the comparison (and, optionally, derive the characteristic(s)). Further, the data storage unit 18 (previously in the server) which stores interaction data is located in the data collection unit of FIG. 1. The processor 11 of the data collection unit can, instead of the processor 16 in the server, compare the obtained interaction data and optionally its derived characteristic to interaction data stored in the data storage unit and its corresponding characteristic. In such an embodiment the server 2 is no longer required, as the data collection unit 1 performs the core functionality of the system.

Optionally, the user identification system may transmit interaction data and/or user identification results to another device connected to the same network, e.g. a server in charge of access control to a building via its network socket.

The characteristic(s) derived from the stored interaction data may be stored in the data storage unit (on either server 2 or data collection unit 1) together with its corresponding interaction data, such that either processor 11 or 16 can use both in comparisons with obtained interaction data and its corresponding characteristic. In other examples, the respective processor first accesses the stored interaction data, then derives a corresponding characteristic from it, and uses the derived characteristic (and, optionally, the stored interaction data) in the comparison. Optionally, the user identification system may include a network socket for communicating interaction data and/or user identification results to another device connected to the same network, e.g. a server.

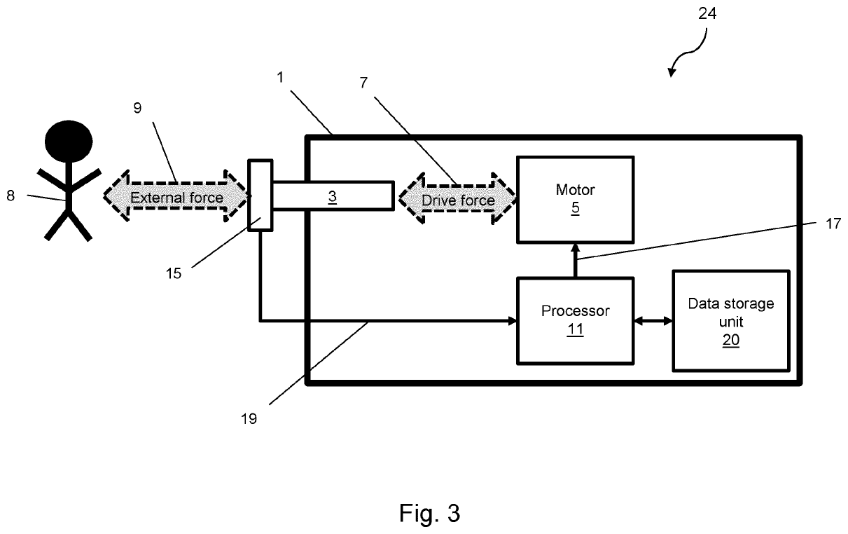

FIG. 3 shows a schematic of a user registration system 24. The system 24 includes a mechanical interaction element 3 such as a pin or rod of the same type as that used in the user identification system 22 of FIG. 2. A drive mechanism in the form of a motor 5 provides a drive force 7 to the interaction element which causes it to move. The interaction element may also be moved manually by a user 8 applying an external force 9 to the interaction element. Thus, the motion of the interaction element depends on the direction and magnitude of the sum of the drive force and the external force.

A processor 11 of the same type as the processor of the data collection unit of FIG. 2 is provided to control the drive mechanism 5 and the drive force 7. A position encoder (not shown, but which may be located within the motors themselves) reports a current location of the interaction element 3 to the processor 11. Additionally, a sensor 15 of the same type as the sensor of the user identification system 22 of FIG. 2 is provided, physically separate to the drive mechanism, which measures a level of interaction by the user 8. The measured external force is reported to the processor 11. In examples where the interaction element comprises one or more flexible membranes encasing a fluid, the sensor 15 may be a pressure sensor configured to sense the pressure of the fluid, or the sensor may measure an amount of fluid entering or exiting the space defined by the flexible membrane via an exit conduit.

The measured position and the measured external force form interaction data which the processor 11 stores on the data storage unit 20. The interaction data may optionally also include time information characterising the interaction. The processor 11 may also be configured to derive a characteristic which is indicative of the identity of the user 8, from the obtained interaction data, and to store it in the data storage unit 20. Similarly to the user identification system 22 of FIG. 2, the characteristic may be shape information characterising the shape of the body part of the user used to interact with the interaction element. Shape information is suitable for user identity determination as it is largely unaffected by the external conditions during use such as level of light or humidity, or the presence of protective apparel, such as gloves.

Additionally or alternatively, the user registration system 24 may further have a network socket configured to communicate with the data storage unit 20 and/or the processor 11 to access the obtained interaction data and share it via a network to another device connected to the network, e.g. a server, for storage. Typically, the network is the internet. However, the network could also be a private wired or wireless connection.

Alternative embodiments of the user identification 22 and user registration 24 systems may comprise a plurality of interaction elements and drive mechanisms. For instance, an array of pins may be provided which can sense and transmit more detail about a user's movements. The pins may be, for example, arranged to form a grid and the user may interact with them by pushing on the grid. Thus, more elaborate interaction data can be obtained which could improve the accuracy of any further derived characteristics from the data, such as shape information characterising the shape of a body part of the user used to interact with the grid of pins.

The user registration system 24 may be provided using the same hardware elements as the user identification system 22 shown in FIG. 2. That is, the data collection unit 1 may be operable in the manner discussed above with respect to the user registration system 24. Therefore, one data collection unit may be provided which is operable both to determine the identity of users using interaction data and to register users with the system by storing interaction data. The server 2 in such a system can be used to provide the data storage unit for storing interaction data when users are registered.

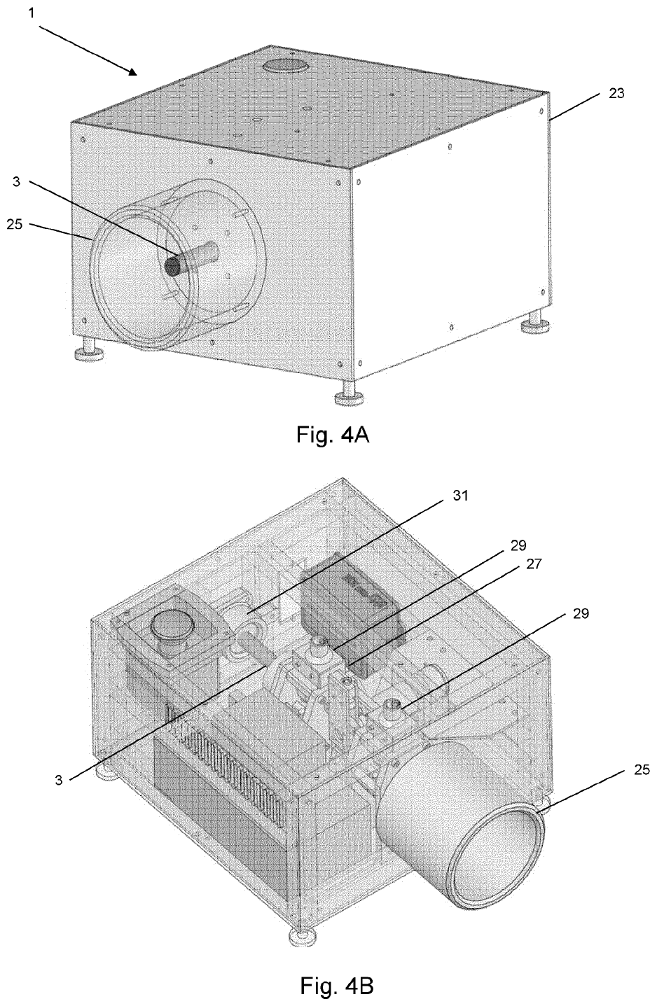

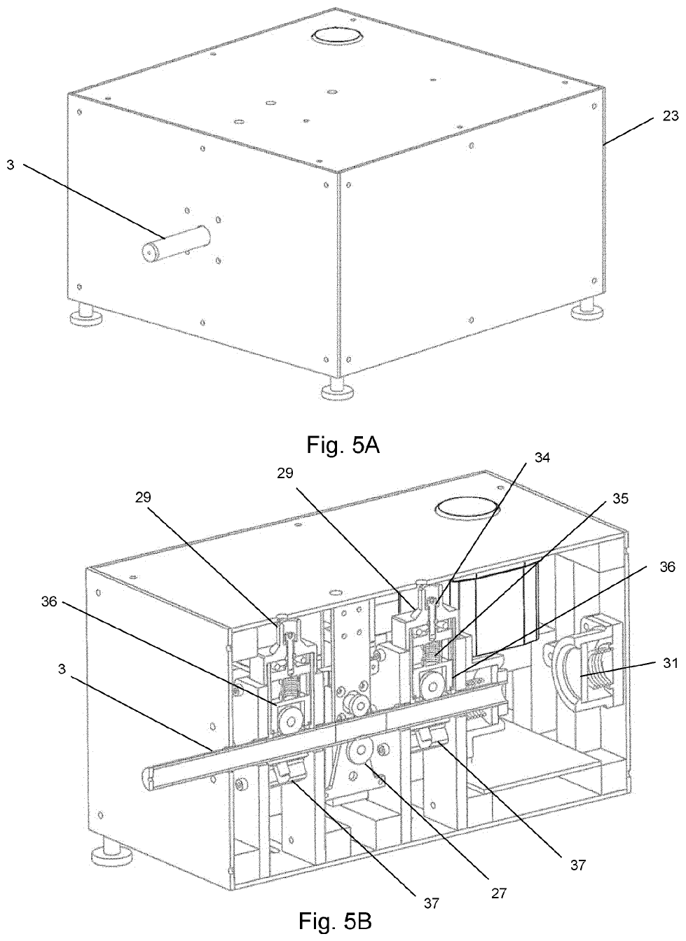

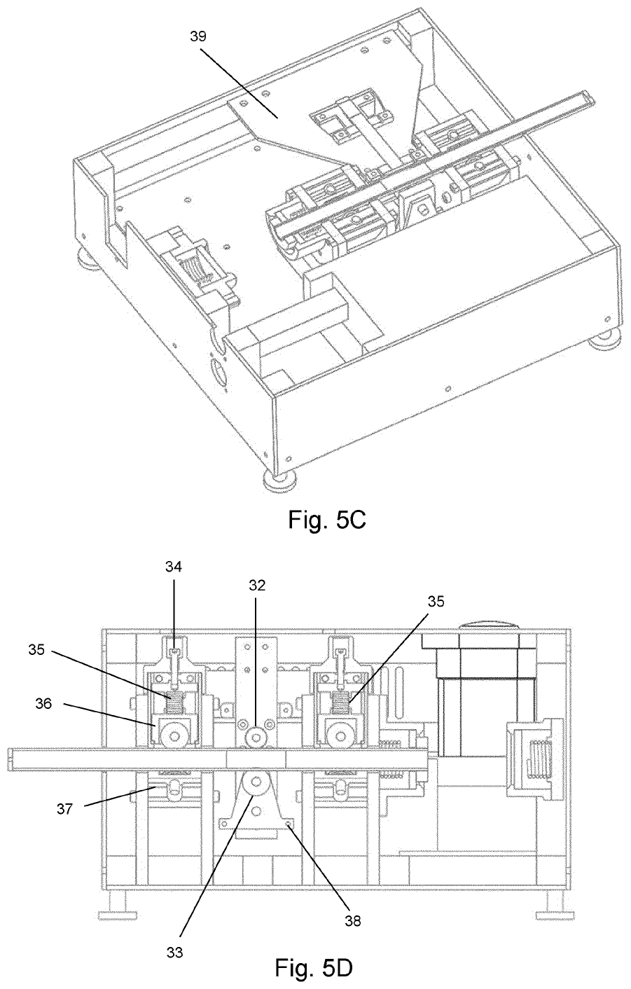

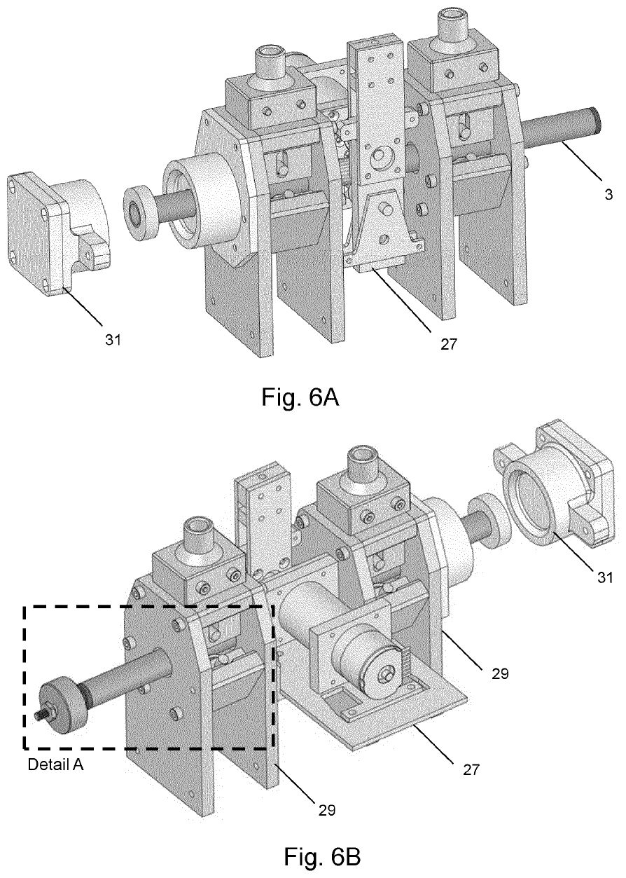

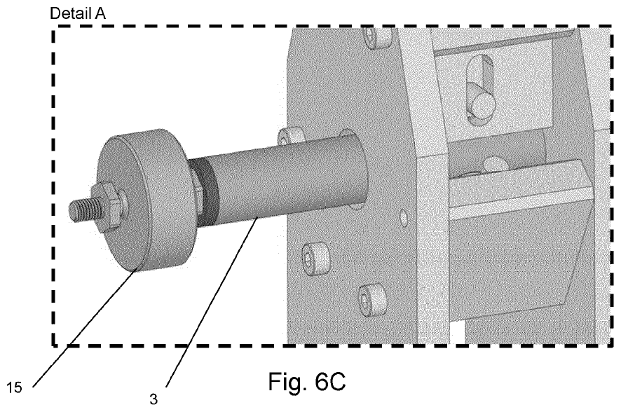

FIGS. 4A and 4B show an external perspective view and an internal perspective view, respectively, of a data collection unit. Additionally, FIGS. 5A to 5D show a perspective view, two different sectioned perspective views, and a sectioned side elevation, respectively, of the data collection unit of FIG. 4A. FIGS. 5A and 5B show perspective views of the drive mechanism of the data collection unit of FIG. 1 and FIG. 5C shows a detailed view of region A of FIG. 5B.

The drive mechanism 5 and the processor 11 of the data collection unit 1 are contained in a housing 23. The mechanical interaction element 3 is a single pin extending from the housing. The pin is protected by a guard 25. The drive mechanism 5 is arranged to drive the pin reciprocally along its longitudinal axis such that the pin moves in and out of the device housing. Thus, in this example, the user 8 can interact with the data collection unit 1 by pushing on the pin.

The drive mechanism 5 is typically a brushless DC motor housed in a motor unit 27, with an internal position encoder. However, alternative drive mechanisms are possible. For instance, the drive mechanism may be a stepper motor, a servo motor, a hydraulic piston, or a pneumatic piston. The drive mechanism may also control the interaction element using electromagnets. Bearing carriers 29 support the pin 3 on either side of the drive mechanism 5. Inside the bearing carriers a preload screw 34 suspends a preload springs 35 which in turn suspends a vertically floating bearing housing 36 above the interaction element. Fixed bearing housings 37 support the interaction element from below. The drive mechanism drives the pin using a drive wheel 33 below the interaction element and a drive wheel 32 above the interaction element which is directly fitted to the motor shaft. The drive wheels are held under tension via springs mounting holes 38 and the preload springs 35 in a manner similar to a locomotive drive system. This ensures a good contact with the interaction element and slippage of the interaction element. A flexural motor and drive bracket 39 are fixed at one end to the housing of the data collection unit to allow for small deviations in the height of the pin 3. A soft-stop damper 31 is provided to limit the maximum displacement of the pin to prevent it moving further than the operational range of the drive mechanism.

A force sensor 15 is positioned on the external facing end of the pin 3. Therefore, when the user presses on the pin they apply an external force directly to the sensor. The force sensor is an inline load cell capable of sensing forces between 0N and 100N. However, other force sensors may be used.

Some motor units 29 may comprise a built-in force (or torque) sensor which may perform a similar force sensing function to the force sensor 15. However, providing a sensor which is separate to the drive mechanism 5 allows a more sensitive sensor to be used. Furthermore, the external forces can be measured independently of downstream mass and friction influences as a result of the drive mechanism 5 and bearing carriers 29. Thus, including a force sensor which is separate to the drive mechanism can enable more accurate and precise measurements of the external force and a better user experience.

The drive mechanism 5 in some examples comprises a motor controller (not shown) which is separate to the processor 11 of the data collection unit 1. The motor controller may be, for example, a Faulhaber MC 5010 S™ motion controller which communicates with the processor 11 over ethernet. An EtherCAT™ network (https://www.ethercat.org/) may be used to exchange data between the processor 11 and the motor controller where the processor is a master device and the motor controllers are slave devices. The motor controller reports motor data to the processor 11 and receives control instructions from it. The control instructions comprise a desired target position for the pin. The processor 11 updates the control instructions for the drive mechanism at regular intervals determined by a system tick. Typically, this happens every 1 ms. However, this interval may be adjusted depending on a desired update rate and the processing capabilities of the processor 11.

On start-up, the processor 11 of the data collection unit 1 runs an initialisation sequence to calibrate the parameters being received from the drive mechanisms 5 and the force sensors 15. During this initialisation sequence, the processor 11 assumes the interaction element 3 is at a zero position and no external force 9 is being applied. Thus, subsequent position changes of the interaction element are measured relative to the zero position. The external force measurement (if not zero) reported by the force sensor 15 during initialisation is designated as a systematic offset and is subtracted from subsequent external force measurements.

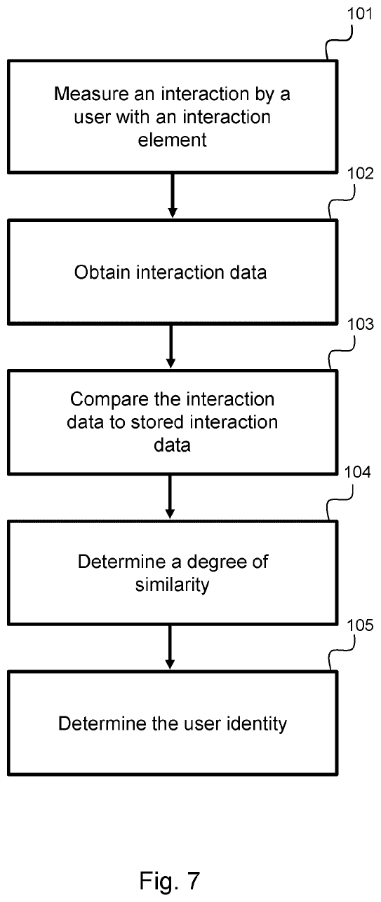

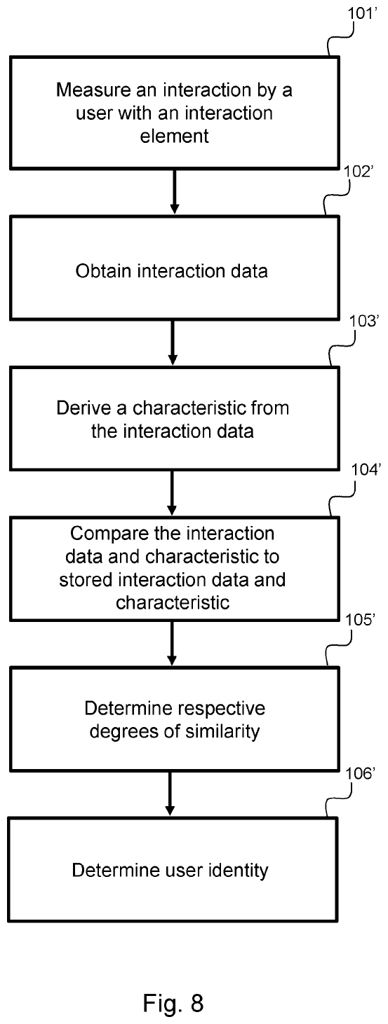

FIGS. 7 and 8 show flow charts of the steps of respective variations of a method of determining a user identity according to aspects of the present invention. According to FIG. 7, a system suitable for implementing the method, e.g. the system 22 of FIG. 2, first measures an interaction by a user 8 with at least one interaction element 3 in step 101. In the next step 102, the system obtains interaction data characterising the interaction. Next, in step 103, the system compares the obtained interaction data to stored interaction data and subsequently, in step 104, determines a degree of similarity between the obtained and stored interaction data. This could be done for example by using fuzzy analytics or a trained machine classifier. In the last step 105, the system determines the user identity, and a decision on allowing access is made based on this determination.

FIG. 8 shows a variant of the method including an additional step 103′ of deriving a characteristic from the interaction data that is indicative of the identity of the user. This may be done by performing one or more calculations using the initially obtained interaction data and a pre-set calculation model, e.g. a formula or set of formulae. Deriving an additional characteristic from the obtained raw data can be beneficial because a more elaborate and therefore reliable user identity determination can be achieved.

The characteristic may include shape information, wherein the shape information may be used to determine the shape of a body part of the user used to interact with the interaction element. For example, a user may interact with the interaction element using their hand. The system would thus obtain interaction data and so derive shape information from the interaction data, characterising the shape of the user's hand to use in the user identity determination. As discussed previously, the determination of a degree of similarity may include one or both of the obtained interaction data and the shape information. Shape information is suitable for user identity determination as it is largely unaffected by the external conditions during use such as level of light or humidity, or the presence of protective apparel, such as gloves. Advantageously, it is also well correlated to the identity of the user.

In this variation of the method, the system suitable for implementing the method, e.g. the system 22 of FIG. 2, derives the characteristic from the interaction data and at the next step 104′ compares both the obtained interaction data and the derived characteristic to corresponding stored interaction data and derived characteristic. Thus, the system is capable of determining respective degrees of similarity between the interaction data and the characteristics, for example by using fuzzy analytics, to determine the user identity.

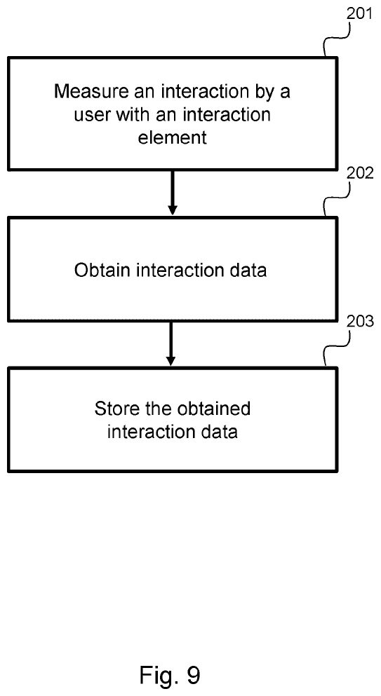

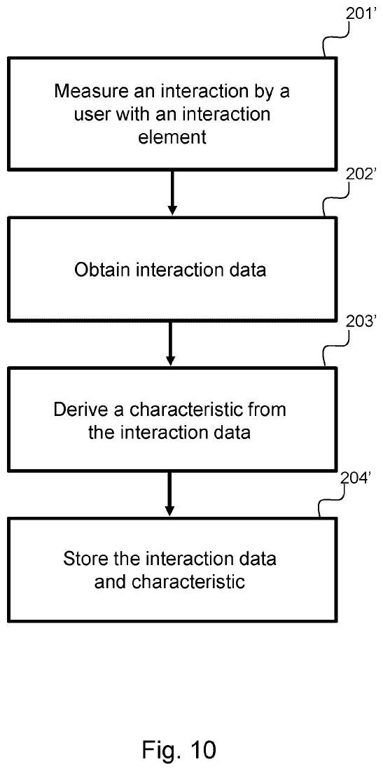

FIGS. 9 and 10 show flow charts of the steps of respective variations of a method of registering users according to aspects of the present invention. According to FIG. 9, a system suitable for implementing the method, e.g. the system 24 of FIG. 3, first measures an interaction by a user 8 with at least one interaction element 3 in step 201. In the next step 202, the system obtains interaction data characterising the interaction. In the final step 203, the system stores the obtained interaction data for use in a method for determining a user identity.

FIG. 10 shows a variant of the method including an additional step 103′ of deriving a characteristic from the interaction data that is indicative of the identity of the user. Similarly to the method shown in FIG. 8, this may be done by performing one or more calculations using the initially obtained interaction data and a pre-set calculation model, e.g. a formula or set of formulae. Deriving an additional characteristic from the obtained raw data can be beneficial because a more elaborate and therefore reliable user identity determination can be achieved.

The characteristic may include shape information, wherein the shape information may be used to determine the shape of a body part of the user used to interact with the interaction element. For example, a user may interact with the interaction element using their hand. The system would thus obtain interaction data and derive shape information from the interaction data characterising the shape of the user's hand to further use in the user identity determination. Shape information is suitable for user identity determination as it is largely unaffected by the external conditions during use such as level of light or humidity, or the presence of protective apparel, such as gloves.

In this variation of the method, the system suitable for implementing the method, e.g. the system 24 of FIG. 3, derives the characteristic from the interaction data and at the next step 204′ stores both the obtained interaction data and the derived characteristic, e.g. on a data storage unit.

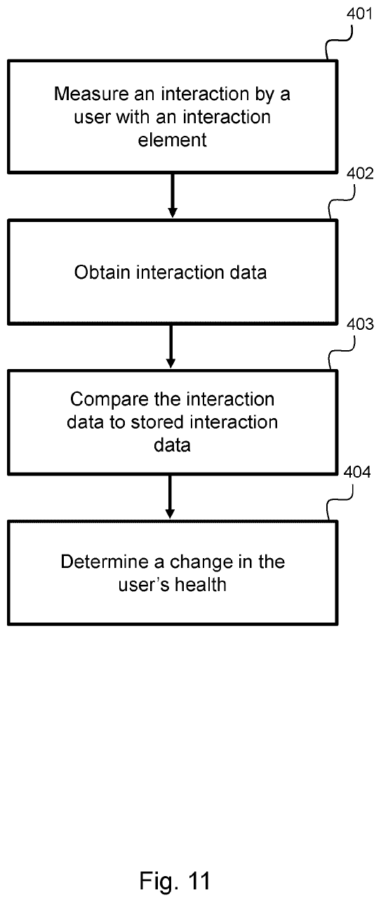

FIG. 11 shows a flow chart of the steps of a method of monitoring a user's health according to aspects of the present invention. The method includes a first step 401 in which an interaction by a user with an interaction element is measured. In the next step 102, the system obtains interaction data characterising the interaction. Next, in step 103, the system compares the obtained interaction data to stored interaction data and subsequently, in step 104, determines whether there has been a change in the user's health. For example, they have become weaker in a given limb or portion of the body.

The features disclosed in the description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

1. A system, the system including:
at least one mechanical interaction element configured for interaction with the user;
a sensor configured to measure the interaction by a user with the at least one mechanical interaction element so as to obtain interaction data;
a data storage unit for storing previously acquired interaction data relating to the user; and
a processor configured to compare the obtained interaction data to the stored interaction data.

2. The system according to claim 1, wherein the interaction data obtained by the sensor is one or any combination of: force data, displacement data, time data.

3. The system of claim 2, wherein the interaction data includes force data and/or displacement data which is within a range of 1 mm to 100 mm.

4. The system of claim 2, wherein the interaction data obtained by the sensor comprises a plurality of sets of interaction data, collected over a plurality of time periods, each set of interaction data being spaced at least 1 ms, 5 ms, 10 ms, 50 ms, or 100 ms apart.

5. The system of claim 1, wherein the processor is configured to store the obtained interaction data for comparison with future obtained interaction data.

6. The system according to claim 1, wherein the at least one mechanical interaction element is a pin.

7. The system according to claim 1, wherein there are a plurality of interaction elements, each being a pin, the plurality of pins being arranged to form a grid.

8. The system according to claim 1, wherein the processor is configured to derive a characteristic, indicative of the identity of the user, from the obtained interaction data and to use the derived characteristic in the comparison.

9. The system of claim 8, wherein the characteristic includes shape information, wherein the shape information is used to determine the shape of a body part of the user used to interact with the interaction element.

10. The system of claim 1, wherein the data storage unit and processor are located in a server which is connected to a data collection unit, the data collection unit containing the at least one mechanical interaction element and the sensor.

11. The system of claim 1, further comprising a drive mechanism, coupled to the mechanical interaction element, and configured to provide a force to the mechanical interaction element in response to the user interaction.

12. The system of claim 1, wherein the system is a user identification system for determining a user identity using interaction data obtained from the user, and wherein the processor is configured to compare the obtained interaction data to the stored interaction data so as to determine a degree of similarity between the obtained and stored interaction data, to allow the user identity to be determined.

13. The system of claim 1, wherein the system is a health monitoring system for determining a user's health using interaction data obtained from the user, and wherein the processor is configured to compare the obtained interaction data to the stored interaction data so as to determine whether the user's health has changed.

14. A method using the system of claim 1, the method including the steps of:
measuring an interaction by a user with the at least one mechanical interaction element and obtaining interaction data; and
comparing the obtained interaction data to stored interaction data.

15. The method according to claim 14, wherein the interaction data is one or any combination of: force data, displacement data, time data.

16. The method according to claim 14, further including a step of deriving a characteristic, indicative of the identity of the user, and using the derived characteristic in the comparison.

17. The method of claim 16, wherein the characteristic includes shape information, relating to a shape of the body part the of the user used to interact with the interaction element, derived from the obtained interaction data, the shape information being used in the step of comparing the obtained interaction data to stored interaction data.

18. The method of claim 14, further comprising providing a force to the mechanical interaction element, via a drive mechanism coupled to the mechanical interaction element, in response to the user interaction.

19. (canceled)

20. (canceled)

21. A method of registering users with a system, the method including the steps of:
measuring, via a sensor, an interaction by a user with at least one mechanical interaction element and obtaining interaction data; and
storing the obtained interaction data for use in a method for determining a user identity.

22. (canceled)

23. (canceled)

24. A user registration system, for registering users, the user registration system including:
at least one mechanical interaction element configured for interaction with the user;
a sensor configured to measure the interaction by a user with the at least one mechanical interaction element so as to obtain interaction data; and
a data storage unit configured to store the obtained interaction data.

25. (canceled)
